(19) United States
(12) Patent Application Publication
(10) Pub. No.: US 2012/0114541 A1
(43) Pub. Date: May 10, 2012

(54) METHOD FOR MANUFACTURING A PRODUCT GAS AND GENERATING STEAM, AND MODULAR PRODUCT GAS-STEAM REACTOR FOR CARRYING OUT SAID METHOD

(76) Inventors: Andreas Schweiger, Graz (AT); Thomas Hochleitner, Graz (AT); Jürgen Karl, Gleisdorf (AT); Thomas Kienberger, Graz (AT)

(21) Appl. No.: 13/125,042

(22) PCT Filed: Oct. 19, 2009
(86) PCT No.: PCT/EP09/63686

§ 371 Date: Dec. 30, 2011

(30) Foreign Application Priority Data
Oct. 20, 2008 (DE) 10 2008 052 374.7
Oct. 20, 2008 (DE) 10 2008 052 375.
Jan. 15, 2009 (DE) 10 2009 004 750.6

(51) Int. Cl. B01D 53/08; B01D 53/00; B01J 19/00

(52) U.S. Cl. 423/245.1; 422/198; 423/210

(57) ABSTRACT

Disclosed is a method for generating steam and manufacturing a product gas by catalytically reacting a feed gas in a reactor unit comprising a reactor tube. Said method encompasses the following steps:—a catalyst bed is conveyed through the reactor tube;—the feed gas is allowed to flow into the catalyst bed against the direction of travel of the catalyst bed;—a temperature profile is regulated along the reactor tube by thermally insulating, heating, and/or cooling regulation sections in the reactor tube; and—the waste heat generated in one of the regulation sections by the cooling action is transferred from the reactor tube to a steam generation unit. The feed gas can be syngas and especially biogas.

The present invention relates to a method for producing steam and a product gas and to a modular product gas/steam reactor for carrying out the method according to the preambles of claims 1 and 12, respectively.

The method of the invention may be subdivided into a first sub-method for producing a product gas and a second sub-method of producing steam which are coupled with each other, wherein the product gas/steam reactor of the invention is suitable for concurrently carrying out both sub-methods. The first sub-method may be associated with a chemical-physical conversion function (e.g., purification) of an educt gas introduced into the product gas/steam reactor, while the second sub-method may be associated with a function of utilizing the energy of the waste heat generated in the chemical-physical conversion.

The conversion/purification of educt gases polluted by particles, sulphur, hydrocarbons and/or chlorine compounds is traditionally realized through a complex combination of several reactors. In this regard the physical separation of the reactors reflects the functional repartition in which each reactor serves for removing one constituent of the impurities, e.g., one chemical element or particle, from the educt gas. The technical and financial expenditure for each single one of these reactors and in particular for their connection and integration to form an overall installation is enormous, for the chemical reactions unfolding in the individual reactors require adequate conditions with regard to temperature and pressure; accordingly, the use of such installations can only be economical upwards from a certain size and a certain throughput of gas.

It is moreover known to generate steam in a steam generation unit from a liquid contained therein by coupling heat into the liquid through appropriate heat transfer means such as, e.g., heat pipes. These heat pipes may, for example, absorb the heat released from the waste heat of a process unfolding upstream by way of cogeneration.

It is an object of the present invention to avoid the drawbacks mentioned in connection with the conversion/purification of educt gases and to combine this process in terms of process technology with the generation of steam in one reactor referred to herein as a product gas/steam reactor, i.e., to synergetically unite the first sub-method with the second sub-method into one process inside a single reactor.

This object is achieved through the features of claims 1 and 12, respectively. Further advantageous aspects are defined in the subclaims.

In accordance with the present invention as defined in claim 1, a catalyst present in the form of a bulk material is conveyed as a moved fixed bed inside a tube or pipe—referred to herein as a reaction tube—in counterflow with an educt gas introduced or fed into the reaction tube, wherein the educt gas flows through a well-defined temperature profile to be thus be processed catalytically in the reaction tube. The temperature profile therefore is a function T(x) of the temperature in dependence on a position x on an abscissa parallel with the longitudinal axis of the reaction tube and subdivides the latter into a plurality of temperature zones, wherein optimum reaction conditions in the respective temperature zones for processing reactions of the passing educt gas taking place there are adjustable. The method of the invention (first sub-method) thus achieves a cancellation of the above-mentioned physical separation of single reactors whose reaction spaces correspond to the temperature zones of the invention. The omission of several separate reactors also does away with the corresponding connection lines and the technically complex maintenance of adequate temperature regimens inside these lines. In accordance with the invention, the temperature profile is generated by thermal insulation, heating, and/or cooling of control sections, wherein it is possible to allocate one control section to each temperature zone. It is clear that even if the controlled temperature profile is a stepped function T(n), with n designating the respective control section, the actual temperature evolution T(x) is a differentiable function. In accordance with the invention, the heat dissipated in the cooling of a control section is supplied to a steam generation unit (second sub-function).

Although claim 2 specifies n=3,with T(1)>T(2)>T(3) successively in the direction of flow, the present invention is not restricted thereto. The number of temperature zones is determined by the reactions taking place in the reaction tube and is subject rather to technical than fundamental limitations.

In accordance with the features of claim 6 a control is performed in the sense that the composition of the product gas is determined, with this composition being utilized as a controlled quantity for the temperature control and/or the throughput. The discharge of reaction heat from control sections having exothermic reactions unfolding inside them may influence the latter in a favorable manner, for as a result the chemical equilibrium may be shifted to the right in accordance with Le Chatelier's principle. The throughput, the reactions taking place in a respective reaction tube, the dischargeable heat etc. are, of course, techno-physical quantities that are not independent of each other but may and need to be harmonized. This opens up several possibilities of intervening in the control process wherein—for instance when the throughput is a variable quantity of a particular control section—this quantity inevitably represents a parameter in all of the other control sections.

In accordance with claim 9, activation of the catalyst may i. a. be achieved through the heat taken from the very educt gas which may, according to claim 11, for instance be synthesis gas from a bioreactor, i.e., biogas having a temperature that is sufficient for activation (heating) of the catalyst. The first sub-method of the method of the invention may thus be a follow-up step of a larger overall process in which a product gas and steam are generated from biomass. The mentioned bioreactor may in this case be, for example, a so-called heat pipe reactor. In addition, according to claim 9 there is a possibility of supplying the heat required for activation of the catalyst from the outside through the product gas/steam reactor, so that the method of the invention is substantially independent of the temperature of the educt gas. In this case, the waste heat of a control section may advantageously be supplied, temporarily or continuously, not to the steam generation unit but to another control section. For example, in an arrangement of control sections A, B, C in the direction of flow it is possible to supply the waste heat of section A having a target temperature T_{A} to section C having a target temperature T_{C} if section B has a target temperature T_{B}, with T_{B} <T_{A}, T_{C}, so that following a temperature reduction in section B a temperature increase is to take place again in section C.

Through the features of claim 10 a further possibility of intervening in the control of the method of the invention is provided, for an alteration of the temperature gradient between the reaction tube and the steam generation unit amounts to an additional degree of freedom in utilizing the waste heats of the individual control sections. An increase of the temperature gradient, i.e., an intensified heat transfer from the reaction tube to the steam generation unit, may be realized, e.g., by transferring the waste heats of a plurality of control sections, whereas in the case of a reduction of the temperature gradient the waste heats may be supplied to other purposes of use.

All in all, the modular concept of the present invention allows coupling not only between the reaction tube as a whole and the steam generation unit, but also between control sections of the reaction tube among each other as well as between these and the steam generation unit.

In accordance with the present invention a product gas/steam reactor is given a modular structure so as to comprise at least one reaction unit (module) including a reaction tube and a heat transfer means through which heat is transferred from the reaction tube into the steam generation unit. This modularity exhibits decisive advantages, as was already addressed in connection with the method of the invention. Firstly, the first submethods of the present invention which take place in the individual reaction units if the product gas/steam reactor includes at least two reaction units, may be identical or different, wherein, e.g., according to claim 11 of the present invention it is possible to preferentially use synthesis gas (e.g., biogas) as an educt gas in one of the reaction units. In a case of n reaction units, a maximum of n different processes may thus take place independently of each other. Secondly, k control sections in each one of the reaction tubes result in a total of n* k control sections and thus—in accordance with the summing formula discovered by Gauss—n*k (n*k +1)/2 possible connections between the control sections, which represents a network that is complex in terms of control technology and accordingly very variable. Thirdly, the reaction units may be “deactivated” and exchanged separately, for example for repair purposes or for a structural modification.

The temperature control units may each partly encompass the respective reaction tube, as is defined in claim 13. For the purpose of a uniform temperature increase or decrease of the respective reaction tube section, the temperature control units preferably have the form of a ring completely encompassing the reaction tube. Advantageously the ring is adapted to be divisible in order to facilitate mounting of the ring on the reaction tube. As an alternative, the temperature control units may encompass respective temperature control elements forming a ring structure that is interrupted in the peripheral direction of the reaction tube. The temperature control device may, e.g., include a thermal conduction arrangement according to claim 14.

Conveying the catalyst bed may substantially be effected through gravity in accordance with claim 15, or with the aid of a conveying device in accordance with claim 18. In case of gravity, conveying by means of a corresponding material lock according to claim 16, for example a cellular wheel sluice or a worm drive according to claim 17, the throughput, i.e., the conveyed amount of catalyst per time unit may be controlled, for instance, with the aid of the reaction tube having an oblique top-bottom arrangement or preferably a vertical arrangement. In accordance with the invention a worm drive may be utilized not only for regulating the throughput in the case of conveying by gravity, but may in accordance with claim 19 of the present invention also be used as a conveyor device, in which case it assumes the conveying function while at the same time regulating the throughput of the conveyed amount of catalyst. In this case the three-dimensional arrangement of the reaction tube may be chosen at will. As an alternative, it is possible to use instead of the worm drive any other conveyor device that is suitable for controlled conveying of pourable bulk material. At only a slight inclination of the reaction tube, a combination of the two options is furthermore conceivable, i. e., a conveyor means may be employed additionally at a slight inclination of the reaction tube in order to overcome frictional resistance. If the material lock is disposed at the second end, with “the catalyst bed sitting on top of it”, then its rotational speed is proportional to the throughput and to the conveying velocity of the catalyst bed in the reaction tube, so that throughput or conveying velocity may be utilized as a controlled quantity. If, on the other hand, the material lock is disposed at the first end, the conveyed quantity is determined by its rotational speed whereas the movement of the catalyst bed downstream from the material lock (i.e., inside the reaction tube) is determined by the law of gravitation to thus be invariable.

In accordance with the feature of claim 20 of the present invention, the reaction tube—which according to claim 12 is not fixedly determined with regard to shape and orientation and thus is globally straight or circular, for example—is formed or composed of straight and curved sections. This option fundamentally exists in accordance with the invention both for conveying by gravity and also for conveying with the aid of a conveyor device. In the former case, the conveying force exerted by the gravity of the catalyst present in vertical sections of the reaction tube or in sections thereof extending obliquely from top to bottom must, of course, be sufficient to overcome horizontal sections or less steep sections of the reaction tube or to overcome friction. In the latter case, e.g., in a reaction tube extending only in a horizontal plane, conveying may advantageously be facilitated by vortexing of the catalyst bed to thus create a moved fluidized bed.

As may be seen from the above discussion, the temperature profile and the dwell time of the catalyst in the single temperature zones, which is tied in with the throughput (conveying velocity), are crucial for the degree of conversion efficiency of the educt gas. Therefore, the reactor according to claim 21 of the present invention includes a gas detector for detecting the conversion efficiency by determining the composition of the product gas which serves as a controlled quantity. Subsequently it is possible, for example, to compare the measured composition (controlled quantity) to a target quantity (command variable) and supply the control difference to a controller driving, e.g., a potentiometer as an actuator for altering the current intensity of the temperature control device or the temperature control units thereof, respectively. It is possible to integrate the flow velocity of the educt gas into the control loop as a load disturbance variable. It should be noted that different reactions take place in the respective temperature zones, so that, for instance, the temperature control unit to be driven is determined by the composition of the product gas. As an alternative it is possible to compare the composition of the product gas to a target value, with the control difference altering a command variable of a temperature control, i.e., it would be necessary to provide a separate temperature control including corresponding temperature measurements, etc. What is in any case decisive for the desired composition of the product gas is an interrelation of flow velocity of the educt gas, condition and throughput of the catalyst, temperature ranges, and not least composition or type of the impurity of the educt gas.

The features of claim 22—as specified in claim 23—provide a definition of a temperature drop in the direction of flow of the educt gas as a temperature profile, which temperature drop may be approached, e.g., to a linear one at corresponding sizes of the individual temperature control units, with the highest temperature prevailing in the vicinity of the educt gas inlet of the reaction tube. This has the advantage of optimum utilization of the thermal energy of the educt gas. Here the quantity “temperature ‘zone’ ” has the dimension [length] (along the reaction tube). In particular, a temperature zone may include a plurality of temperature control units controlling, e.g., a constant temperature or a temperature gradient on the corresponding reaction tube section.

The features of claim 24 allow to achieve high flexibility and maintenance capability of the reactor of the invention, for its modular construction allows the exchange of single modules, for example for repair purposes, as well as an adaptation of the shape to on-site conditions. In particular it is very easy to configure a temperature profile consisting of cooling and heating zones. This modular concept has already been mentioned in the foregoing; it includes the single control sections of an individual reaction tube as well as the individual reaction units inside a larger overall system.

The reactor of the invention does, of course, possess corresponding devices, ports, feed and discharge lines, which allow the above-described structure to function and the realization of which is familiar to the person having skill in the art.

In accordance with claim 26, a catalyst is conveyed as a moved fixed bed inside a reaction tube opposite to the direction of flow of an educt gas being processed catalytically with the aid of the catalyst in the reaction tube, wherein the educt gas passes through a predetermined temperature profile. The temperature profile is constructed in three dimensions of several temperature zones having differently high temperature ranges, with optimum reaction conditions for particular reactions in the processing of the educt gas being created in the respective temperature zones. The method of the invention results in the elimination of the above-addressed physical separation of single reactors whose reaction spaces correspond to the temperature zones of the invention. The omission of several separate reactors also does away with the corresponding connection lines and the technically complex maintenance of adequate temperature regimens in these lines.

In accordance with claim 27 the reaction unit may be integrated into the evaporator unit, i.e., each reaction unit from among a plurality of reaction units may be integrated into the evaporator unit, so that the product gas/steam reactor of the invention may also be adapted to the space conditions. Integration into the evaporator unit moreover has the advantage of optimum heat transfer from corresponding control sections into the evaporator unit.

Further properties and advantages of the present invention become evident from the following detailed description making reference to the annexed drawings, wherein:

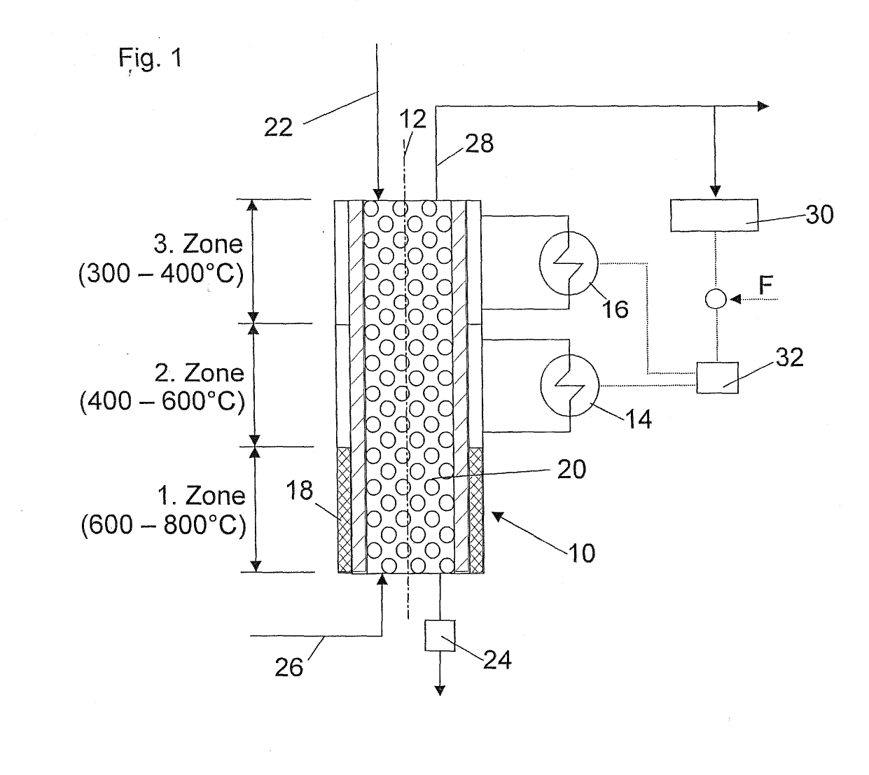

FIG. 1 is a schematic sectional view of a reaction tube of the invention for carrying out the method of the invention of producing steam and product gas by catalytic conversion of an educt gas.

FIG. 1 schematically shows a sectional view of a reaction tube 10 according to one embodiment of the present invention and having a longitudinal axis 12, in the direction of which the reaction tube 10 is subdivided into a first, a second, and a third temperature zone, respectively having a high temperature range between 800° C. and 600° C., a medium temperature range between 600° C. and 400° C., and a low temperature range between 400° C. and 300° C.; and

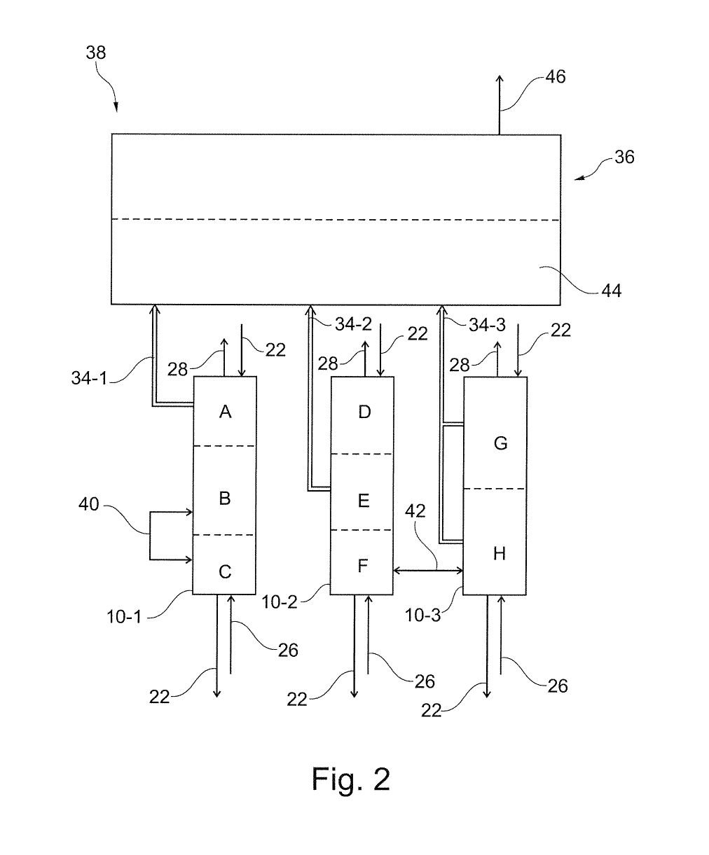

FIG. 2 schematically shows an arrangement of several (here: three) reaction tubes combined via respective heat transfer units with a steam generation unit to form a modular product gas/steam reactor in accordance with the present invention.

In FIG. 1, Zone 2 and Zone 3 are cooled by temperature control units 14 and 16, respectively, whereas heating of Zone 1 is accomplished by the educt gas itself having a temperature of approx. 800° C., and its temperature is maintained by a thermal insulation 18.

A catalyst bed 20 forming a moved fixed bed is conveyed in the direction of arrow 22 in the drawing from a first end of the reaction tube 10 positioned at the top to a second end of the reaction tube 10 situated at the bottom, with the throughput being adjusted with the aid of a material lock 24. The educt gas is fed into the reaction tube 10 from below in the direction of arrow 26 representing a feeding line of the educt gas, and withdrawn on the opposite side in the processed condition as a product gas via a corresponding line 28. The direction of flow of the educt gas thus is opposite to the moving or conveying direction of the catalyst bed 20.

In Zone 1, the long-chained and ring-shaped hydrocarbons are reformed with the aid of the steam present in the educt gas, i.e., they are transformed into carbon monoxide and hydrogen. The particles from the gas phase are retained in the catalyst bed which serves as a so-called deep bed filter. In the following Zone 2, the gas is cooled down to the temperature specified in the foregoing. In Zone 3, the sulphur contained in the educt gas is absorbed and bound chemically, and the educt gas is methanized. Spent catalyst is replaced with fresh catalyst by continuous replenishing or conveying of the catalyst bed 20.

For a control of the composition of the product gas, the latter is measured as a controlled quantity by a gas detector 30 connected to line 28, the measured value is compared to a command variable F, and the control difference is fed to a control unit 32 which actuates the temperature control units 14 and 16 by appropriate actuators in accordance with the control difference. In FIG. 1 the control loop is indicated schematically by dotted lines.

FIG. 2 schematically shows an arrangement of three reaction tubes 10-1 to 10-3 which is connected, via respective heat transfer units 34-1 to 34-3 represented by unidirectional arrows “” in FIG. 2, to a steam generation unit 36 to form a modular product gas/steam reactor 38 in accordance with the present invention, with reaction tube 10-i and heat transfer unit 34-i (i=1, 2, 3) jointly forming a reaction unit. As is shown in FIG. 2, each of the reaction tubes 10-i is subdivided into control sections, the limits of which are indicated by dashed lines, and which are designated by letters A-H. Each control section A-H corresponds to a temperature zone which may be adjusted by a control unit allocated to it. Each of the reaction tubes 10-i includes a feed line 26 for educt gas and a discharge line 28 for product gas represented by respective arrows in FIG. 2 so as to indicate the directions of flow. The direction of flow of the moved catalyst bed 20 is shown at the top and bottom by respective arrows 22. As is shown in FIG. 2, the reaction tubes 10-1 and 10-2 each include three control sections A-C and D-F, respectively, while the reaction tube 10-3 merely includes two control sections G and H. The number of control sections of the individual reaction tubes 10-i is only given by way of example, of course. FIG. 2 furthermore gives a schematic and exemplary representation of a heat transfer means for transferring heat between two control sections of a same reaction tube (10-1) through a double arrow “⇄” 40 and between two control sections of different reaction tubes (10-2 and 10-3) through a double arrow “⇄” 42. As is shown in FIG. 2, the heat transfer means 34-1 is connected to only one control section, namely, the upper control section A of the reaction tube 10-1, and the heat transfer means 34-2 is also only connected to one control section, namely, the intermediate control section E B of the reaction tube 10-2. The heat transfer means 34-3, however, is connected to the upper and the lower control sections G, H of the reaction tube 10-3. In accordance with the embodiments, all of the connections (heat transfer paths) include appropriate dispositions (not shown) for enabling and interrupting thermal conduction through them.

The end of the heat transfer means 34-i facing away from the respective reaction tube 10-i opens into the steam generation unit 36, where heat is given off to a liquid medium 44 and the latter is taken to thereby transformed into its vapor state. The steam thus generated is withdrawn via a corresponding gas exit opening 46 and supplied to another use.

Although the present invention was disclosed with a view to the preferred embodiments thereof in order to enhance comprehension, it should nevertheless be noted that the invention may be realized in various ways without departing from the scope of the invention. The invention should therefore be understood to encompass any possible embodiments and aspects for the shown embodiments that may be realized without departing from the scope of the invention as defined in the annexed claims.

### LIST OF REFERENCE NUMERALS

10 (i) reaction tube
12 longitudinal axis of 10
14 temperature control unit
16 temperature control unit
18 thermal insulation
20 catalyst bed
22 direction of movement of the catalyst bed
24 material lock
26 educt gas feeding line
28 product gas withdrawal line
30 gas detector
32 control unit
34-i heat transfer units
36 steam generation unit
38 product gas / steam reactor
40 heat transfer means
42 heat transfer means
44 liquid medium
46 gas exit opening

1. A method of producing steam and a product gas by catalytic conversion of an educt gas in a reaction unit comprising a reaction tube, said method including the steps of:
conveying a catalyst bed through the reaction tube;
feeding the educt gas into the catalyst bed opposite to the conveying direction of the catalyst bed;
controlling a temperature profile along the reaction tube by independently controlling control sections of the reaction tube by thermal insulation, heating, and cooling; and
transferring the waste heat generated by cooling in one of the control sections from the reaction tube into a steam generation unit.

2. The method according to claim 1, characterized in that the temperature profile includes, in the direction of flow of the educt gas and consecutively in this order, a first temperature zone having a first, higher temperature range, a second temperature zone having a second, medium temperature range, and a third temperature zone having a third, lower temperature range.

3. The method according to claim 2, characterized in that the first, higher temperature range is situated between 800° C. and 600° C., the second, medium temperature range between 600° C. and 400° C., and the third, lower temperature range between 400° C. and 300° C.

4. The method according to claim 2, characterized in that tar contents in the educt gas are reformed in the first temperature zone, that the educt gas is cooled in the second temperature zone, and that the educt gas is methanized and at the same time sulphur is removed from the educt gas through adsorption to the catalyst in the third temperature zone.

5. The method according to claim 1, characterized in that the catalyst bed acts to filter solid particles from the educt gas.

6. The method according to claim 1, characterized in that the composition of the product gas is determined and the composition of the product gas is used as a controlled quantity for the temperature control and/or for the throughput.

7. The method according to claim 1, characterized in that the catalyst used contains nickel, cobalt and/or the noble metals of Group VIII of the periodic system as active components.

8. The method according to claims 1, characterized in that the reaction unit includes a heat transfer means for transferring the waste heat from the reaction tube into the steam generation unit, and steam is generated in the steam generation unit of a liquid provided therein.

9. The method according to claim 1, characterized in that activation of the catalyst is achieved through heat which is supplied to a controlling section of the reaction tube from outside and/or which is withdrawn from the very educt gas.

10. The method according to claim 1, characterized in that it a temperature gradient between the reaction tube and the steam generation unit is adjustable.

11. The method according to claim 1, characterized in that the educt gas is synthesis gas and in particular biogas.

12. A modular steam/product gas reactor for carrying out the method according to claim 1, comprising:
a steam generation unit; and
at least one reaction unit which includes a reaction tube and a heat transfer means through which heat from the reaction tube is transferred into the steam generation unit;
the reaction tube comprising:
a first end and a second end, with a catalyst bed being conveyed from the first end to the second end;
a catalyst inlet at the first end;
a catalyst outlet at the second end;
an educt gas inlet for feeding an educt gas at the second end;
a product gas outlet for withdrawing the produced product gas at the second end; and
a temperature control device including a plurality of temperature control units which are arranged along the reaction tube, for controlling a temperature profile along the reaction tube by independently controlling control sections of the reaction tube through thermal insulation heating, and/or cooling.

13. The reactor according to claim 12, characterized in that each of the plurality of temperature control units at least partly encompasses the reaction tube.

14. The reactor according to claim 12 or 13, characterized in that the temperature control device includes a heat pipe arrangement.

15. The reactor according to claim 12 any one of claims 12 to 11, characterized in that the reaction tube is a down pipe, that the catalyst bed is pourable, and that the catalyst inlet is provided at the first, upper end and the catalyst outlet at the second, lower end of the down pipe.

16. The reactor according to claim 15, characterized in that the reaction tube includes a material lock for control of the throughput of the catalyst conveyed by gravity.

17. The reactor according to claim 16, characterized in that the material lock is a cellular wheel sluice or a worm drive.

18. The reactor according to claims 12 12 to 11, characterized in that the reaction tube includes a conveyor device for conveying the catalyst bed, with said conveyor device controlling the throughput.

19. The reactor according to claim 18, characterized in that the conveyor device is a worm drive.

20. The reactor according to claims 12 12 to 19, characterized in that the reaction tube is formed of straight and curved sections.

21. The reactor according to claim 12 any one of claims 12 to 20, characterized in that a gas detector for determining the composition of the product gas is provided, and in that the composition of the product gas is a controlled quantity. LA2:927350.1 6

22. The reactor according to claim 12, characterized in that the temperature profile created by the temperature control device includes, in the direction of flow of the educt gas and consecutively in this order, a first temperature zone having a first, higher temperature range, a second temperature zone having a second, medium temperature range, and a third temperature zone having a third, temperature range.

23. The reactor according to claim 22, characterized in that the first, higher temperature range is situated between 800° C. and 600° C., the second, medium temperature range between 600° C. and 400° C., and the third, lower temperature range between 400° C. and 300° C.

24. The reactor according to claim 12, characterized in that the reaction tube may be composed of a plurality of modules, each module being constituted of a tube section and at least one temperature control unit for thermal insulation, cooling, or heating.

25. The reactor according to claim 12, characterized in that the catalyst contains nickel, cobalt and/or the noble metals of Group VIII of the periodic system as active components.

26. The reactor according to claims 12, characterized in that it includes a plurality of reaction units arranged in parallel.

27. The reactor according to claim 12, characterized in that the reaction unit is integrated into the evaporator.
